(19) United States
(12) Patent Application Publication
(10) Pub. No.: US 2008/0262962 A1
(43) Pub. Date: Oct. 23, 2008

(54) System and method for coordinating student loans

(76) Inventor: Keith Alliotts, Tenafly, NJ (US)

Correspondence Address: BLANK ROME LLP, 600 NEW HAMPSHIRE AVENUE, N.W., WASHINGTON, DC, 20037, US

(21) Appl. No.: 11/889,128

(22) Filed: Aug. 9, 2007

Related U.S. Application Data
(60) Provisional application No. 60/907,879, filed on Apr. 20, 2007.

(51) Int. Cl. G06Q 40/00

(52) U.S. Cl. 705/38

(57) ABSTRACT

A system and method that allows coordination of loans by providing a web site where borrowers can enter personal information and receive a listing of multiple lending institutions interested in entering into loan agreements with those borrowers. Other applications of the system and method include, but are not limited to, tracking referrals of borrowers to lending institutions made based on selection criteria submitted by the lending institutions and personal information submitted by the borrower for purposes of collecting a referral fee from the lending institution paid to referring agents.

### BACKGROUND OF THE INVENTION

1. Field of Invention

The present invention relates generally to the field of electronic commerce using a networked communications system. More particularly, the invention relates to systems and methods for coordinating student loan borrowers and lending institutions via an on-line web site.

2. Description of Related Art

Lending institutions rely on different techniques for generating new clients, including promotion and advertising techniques, affiliation programs, and referrals. Referrals are clients that have learned about the lending institutions through word-of-mouth endorsements, third party loan originators, and other persons. Traditionally, third party loan originators would receive a referral fee from the lending institutions for every bare, partial-qualified, or qualified lead, depending on the terms of the referral program. With the Internet touching nearly every channel of goods and services in commerce today, it makes sense to use the Internet to increase the number of referrals that lending institutions receive by providing a convenient web-site where borrowers can search for and contact several lending institutions at a single user session.

Student loans are no exception. Traditional methods of applying for student loans involved a borrower contacting individual lending institutions via a communications network, such as via a telephony or Internet system, to learn whether any of the contacted lending institutions would be interested in entering into a loan agreement with the borrower. Each contact would involve providing personal information to the lending institutions, such as the borrower's name, contact information, the state where the borrower's school is located, the amount to be borrowed, any credit history or co-borrower information, and other information requested by the lending institution. Then, if the lending institution were interested in working with the borrower, based on its review of the information provided by the borrower and other information about the borrower available from third parties, the lending institution would provide to the borrower its terms and conditions associated with the lending institution's loan programs. The borrower would then review those terms and conditions, and any terms and conditions provided by other lending institutions, before making a decision regarding whether to enter into a loan agreement.

To simplify that process, systems and methods for collecting borrower data and transmitting that data to lending institutions after filtering the data based on selection criteria provided by the lending institution have been developed. The inventions disclosed in U.S. Pat. Nos. 6,385,594 and 6,611,816, for example, relate to coordinating an electronic credit qualification form between an Internet user and multiple lending institutions via the Internet. The disclosed inventions include a method and computer system for displaying forms on a web site and receiving credit data from users via those forms. After receiving the data, a loan processing computer applies a filter to the data comprising loan selection criteria provided by lending institutions. That filter eliminates loan applications that the lending institutions do not want. Next, after the received data are filtered, the data are transmitted to the lending institutions. Finally, the computer and the method controls and coordinates communication between the lending institutions and the user to match borrowers and lenders via the Internet.

In a broader context, the invention disclosed in U.S. Patent Appl. Pub. No. 2004-0205019 relates to a loan processing computer that automatically applies a first filter to the user's data, and then uses a second filter that can be applied to qualification form data that remains after the first filter, in order to identify potential borrowers. That second filter can by customized by a financial service provider who can also control the process of applying the second filter in a semi-manual manner.

Systems and methods for coordinating financial services between consumers and financial service providers and wholesale investors have also been developed in recent years. The invention disclosed in U.S. Patent Appl. Pub. No. 2006-0100944 (“the '944 application”), which is entitled “Method and computer network for coordinating financial services/products,” relates to coordinating an electronic qualification form between consumers and financial service providers and wholesale investors.

Computer systems that allow borrowers to access mortgage information over the Internet have also been developed. For example, the invention disclosed in U.S. Patent Appl. Pub. No. 2004-0199458 relates to a system that allows consumers to access mortgage information and mortgage financing through a computer network.

The invention disclosed in U.S. Pat. No. 5,995,947 relates to trading loans in real time by making loan applications, such as home mortgage loan applications, and placing them up for bid by a plurality of potential lenders.

What the aforementioned prior art systems and methods fail to address, however, among other things, is the data security and liability concerns raised by transmitting personal information collected about borrowers to the lending institutions. Also, the aforementioned systems and methods can be overly complicated, in view of the fact that many lending institutions simply want potential customer leads that they can turn into actual revenue-generating customers. Systems and methods that focus on simplifying the process of sending qualified customer leads to lending institutions, and that account for the data security and liability concerns associated with using electronic communications of personal information, would be highly desirable.

### SUMMARY AND OBJECTS OF THE INVENTION

It should be apparent that there exists a need for a system and method for coordinating student loans over a communications network, like the Internet, that does not involve transmitting to the lending institution personal information collected about the borrower. There also exists a need for a system and method that can track successful referrals of borrowers to lending institution without transmitting any information regarding the borrower to the lending institution. To facilitate and simplify such a system, the coordinator should be barely visible in the process.

Accordingly, a principal object of the present invention is to provide systems and methods for coordinating student loans, by providing a web site where borrowers can enter personal information and receive a listing of multiple lending institutions interested in entering into loan agreements with those borrowers.

It is another object of the invention to provide a system and method for coordinating student loans, by identifying potential borrowers and referring them to lending institutions which then may enter into loan agreements with those borrowers.

It is still another object of the invention to provide a system and method for coordinating student loans, by minimizing the interaction of the coordination system so that borrowers and lending institutions are put in contact with each other in an expedited manner.

It is another object of the present invention to provide a system and method for referring borrowers interested in borrowing money that have been prescreened to meet certain lending institution criteria to lenders without directly transmitting the personal information of the borrower.

It is still another object of the present invention to provide a system and method for maintaining a database of lending institution selection criteria allowing the selection criteria to be matched against each borrower that submits personal information to the system.

It is another object of the present invention to provide a system and method for tracking referrals made by the system of borrowers to lending institutions for purposes of collecting a referral fee from the lending institutions.

It is still another object of the present invention to provide a system and method for automatically generating an invoice detailing referrals made to facilitate referral fee collection.

Briefly described, those and other objects and features of the present invention are accomplished, as embodied and fully described herein, by a system for coordinating student loans that includes a server in data communication with one or more lending institutions and one or more borrowers interested in borrowing money, one or more lending institution client computers for entering and sending a plurality of selection criteria to the server, one or more borrower client computers for entering and sending a set of personal information to the server, and a data processing component for comparing the set of personal information to the plurality of selection criteria and returning a list of one or more matching lending institutions to the borrower.

The system includes a web server for serving Internet web pages, a list of one or more matching lending institutions containing one or more HTML links to a web page of the matching lending institution, a lending institution database accessible by the server containing a plurality of selection criteria for the one or more lending institutions, and a borrower database accessible by the server containing a plurality of sets of personal information for the one or more borrowers interested in borrowing money.

The objects and features of the system also include a mechanism for receiving at the server a signal from the one or more borrower client computers indicating that the borrower has clicked on at least one of the HTML links.

The objects and features of the present invention are also accomplished, as embodied and fully described herein, by a method involving the steps of receiving at a first server over a first communications network a set of selection criteria from each of a plurality of lending institutions; receiving at the first server over a second communications network a set of personal information from a first borrower; comparing at the first server the set of personal information to each of the sets of selection criteria; identifying at the first server which of the sets of selection criteria are satisfied by the set of personal information; outputting from the first server over the second communications network information containing instructions to generate a link on a client computer associated with each of the identified selection criteria, wherein the link is associated with at least one of the plurality of lending institutions; and receiving at the first server over the second communications network a signal from the client computer when the link has been activated.

With those and other objects, advantages and features of the invention that may become hereinafter apparent, the nature of the invention may be more clearly understood by reference to the following detailed description of the invention, the appended claims and to the several drawings attached herein.

### BRIEF DESCRIPTION OF THE DRAWINGS

FIG. 1 is a drawing depicting a schematic of the general system architecture of a loan coordinating system according to one aspect of the present invention;

FIG. 1A is a drawing depicting a schematic of the system architecture of a loan coordinating system according to one aspect of the present invention;

FIG. 2 is drawing depicting a schematic of the client-server architecture of a loan coordinating system according to one aspect of the present invention;

FIG. 3 is a schematic drawing depicting the server-side architecture of a loan coordinating system according to one aspect of the present invention;

FIG. 4 is another schematic drawing depicting the server-side architecture of a loan coordinating system with communications to various third party information providers according to one aspect of the present invention;

FIG. 5 is another schematic drawing depicting the server-side architecture of a loan coordinating system with a database external to the server(s) according to one aspect of the present invention;

FIG. 6 is another schematic drawing depicting the server-side architecture of a loan coordinating system with a database internal to the server(s) according to one aspect of the present invention;

FIG. 7 is another schematic drawing depicting the server-side architecture of a loan coordinating system with a database for storing lender selection criteria and borrower personal information according to one aspect of the present invention;

FIG. 8 is a schematic drawing of a system for coordinating loans through a loan aggregator according to one aspect of the present invention;

FIG. 9 is a schematic drawing depicting the lending institution client-side architecture of a loan coordinating system according to one aspect of the present invention;

FIG. 10 is another schematic drawing depicting the lending institution client-side architecture of a loan coordinating system with a plurality of lending institutions according to one aspect of the present invention;

FIG. 11 is another schematic drawing depicting the lending institution client-side architecture of a loan coordinating system with a plurality of lending institutions and a lending institution aggregator according to one aspect of the present invention;

FIG. 12 is a schematic drawing depicting the borrower client-side architecture of a loan coordinating system according to one aspect of the present invention;

FIG. 13 is another schematic drawing depicting the borrower client-side architecture of a loan coordinating system with a plurality of borrowers according to one aspect of the present invention;

FIG. 14 is another schematic drawing depicting the borrower client-side architecture of a loan coordinating system with a plurality of borrowers and a borrowing aggregator according to one aspect of the present invention;

FIG. 15 is another schematic drawing depicting the borrower client-side architecture of a loan coordinating system with communications to various third party information providers according to one aspect of the present invention;

FIG. 15A is a drawing representing an HTML link containing borrower personal information according to one aspect of the present invention;

FIG. 16 is a process flow diagram depicting the server-side process flow according to an embodiment of the present invention;

FIG. 16A is a process flow diagram depicting the server-side and client-side process flow according to an embodiment of the present invention;

FIG. 17 is a process flow diagram depicting the borrower client-side process flow according to an embodiment of the present invention; and

FIG. 18 is a process flow diagram depicting the server-side referral tracking process flow according to an embodiment of the present invention.

### DETAILED DESCRIPTION OF THE PREFERRED EMBODIMENT

Several preferred embodiments of the invention are described for illustrative purposes, it being understood that the invention may be embodied in other forms not specifically shown in the drawings.

I. System Architecture.

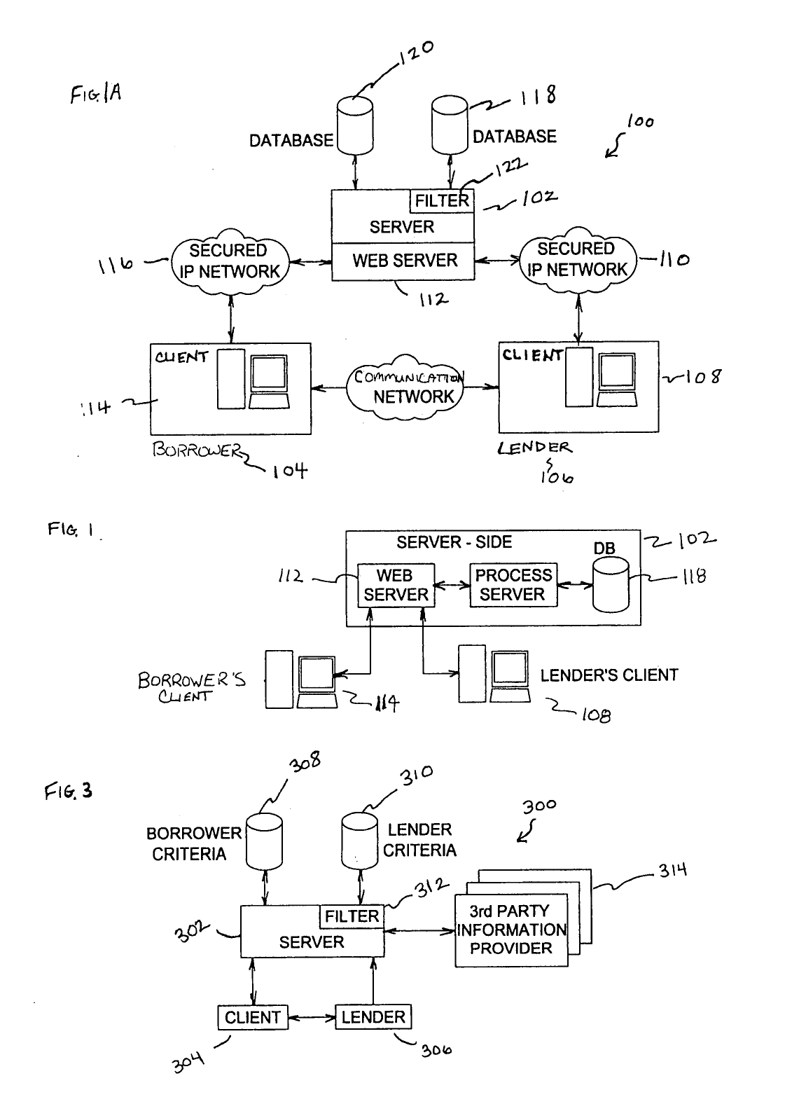

FIG. 1 and FIG. 1A are drawings depicting a schematic of the system architecture of a loan coordinating system 100 according to one aspect of the present invention. For purposes of illustrating the invention, the system 100 will be discussed in connection with a student loan referral program; however, it should be noted that the system 100 could easily be employed in any money-borrowing program, such as automobile loans.

The system 100 includes a server subsystem 102, a borrower 104, and a lending institution 106. The invention contemplates that the lending institution 106 will submit selection criteria to the server subsystem 102 using the lending institution client 108 in data communication over a communications network 110 with a web server 112 in the server subsystem 102. The selection criteria may be saved in a database 118. The borrower 104 will submit personal information using a borrower client 114 in data communication over a communications network 116 with the web server 112 in the server subsystem 102 to make use of the system 100. The personal information may be saved in a database 120, which could be the same as or different than the database 118.

A filtering process 122 in the server subsystem 102 will use the selection criteria stored in the database 118 to identify whether the personal information submitted by the borrower 104 meets the selection criteria submitted by the lending institution 106. Based on the result of the filtering process 122, the web server 112 will generate instructions to be communicated back to the borrower client 114.

In one embodiment, the web server 112 may generate instructions to generate an HTML page describing a simple list of matching lending institutions with contact information. In another embodiment the web server 112 may generate instructions to generate a list of HTML (or other markup language) links to the website of identified lending institutions 106 to be communicated via the communications network 116 to the borrower client 114 for display. As described below, the HTML link may contain data variables representing personal information relevant to the lending institution that can be parsed by the lending institution web server 126. The borrower 104 may then click on a link to access the lending institution web server 126 via the communications network 124. Clicking on a link simultaneously sends a signal from the borrower client 114 to the server system 102 indicating that a successful referral has occurred. The borrower 104 can then interact directly with the lending institution web server 126.

The borrower 104 and lending institution 106 can communicate with and receive information provided by the system 100 using wired or wireless electronic client devices 108, 114. The client devices 108, 114 could be, for example, a wireless telephone, a wired telephone, a personal data assistant, a portable computer, and/or a desktop computer. Combinations of those electronic devices, or other types of electronic devices capable of sending and receiving electronic, optical, and electro-optical signals, may be used.

As shown in FIG. 1, the lending institution client device 108 is connected to a first data communications network 110 and the borrower client device 114 is connected to a second data communications network 116. The lending institution client device 108 and the borrower client device 114 are connected to a third data communications network 124. The particular connectivity of the client devices 108 and 114 to the first, second, and third networks 110, 116, 124 is for illustrative purposes only. The networks 110, 116, 124 may be, for example, a wireless network used by mobile computing devices like cellular telephones, the Internet, an intranet, or some other data communication system. Preferably, the networks 110, 116, 124 are packet-switched networks capable of routing hypertext, extensible, or other types of markup language code and data in accordance with the standard Internet Protocol or some other protocol in order to generate web pages. In particular, data may be exchanged over these networks by employing the Commonline Data standardized format and delivery process commonly used for the exchange of origination, disbursement and change transaction data between educational institutions and their federal and private student loan service providers. The Internet Engineering Task Force is the standards body that creates and maintains the basic standards on which the Internet depends, including the Internet Protocol specification published in 1981.

The first and second networks 110, 116 are connected or interconnected to a server subsystem 102, which can include one or more server computers that are adapted to, among other things, store and process data, protect data and access to the system using a firewall or some other security measure, generate responses to client device requests for markup language files and information, and provide access to user information. The borrower 104 and the lending institution 106 can use one or more of the electronic client devices 108, 114 to access the server subsystem 102, preferably via a web site graphical user interface that is generated on the electronic client devices 108, 114 using markup language commands and data provided to those devices by the server subsystem 102.

The server subsystem 102 is capable of interfacing with one or more databases 118, 120 as shown in FIG. 1. The database 118 could be, for example, a database containing records of each lending institution's 106 profile and selection criteria. The selection criteria could be, for example but not limited to, amount of the loan, state of residence of the borrower, state in which the school attended is located, credit rating, amount of assets, year of graduation, or annual income. The database 120 could be, for example, a database containing borrowers' 104 personal information. The personal information could include, but is not limited to, name, date of birth, address, social security number, amount of loan, credit rating, amount of assets, year of graduation, state in which the school attending is located, annual income, user identification, passwords, and preferences.

As described above, the many objects of the present invention can easily be used in connection with coordinating student loans between borrowers interested in borrowing money and lending institutions interested in lending money to selected borrowers. However, the system can be used in other ways. FIG. 2 is the general client-server architecture of a loan coordinating system 200 according to one embodiment of the invention. As shown, a server subsystem 202 is in data communication with a borrower client subsystem 204 and a lending institution client subsystem 206. Data communication between the server subsystem 202 and the borrower client subsystem 204 occurs over a communications network 208. Data communication between the server subsystem 202 and the lending institution client subsystem 206 occurs over a communications network 210. The borrower client subsystem 204 is in data communication with the lending institution client subsystem over a communications network 212. The communications networks 208, 210, 212 can be separate communications network as illustrated, or the same network (not shown).

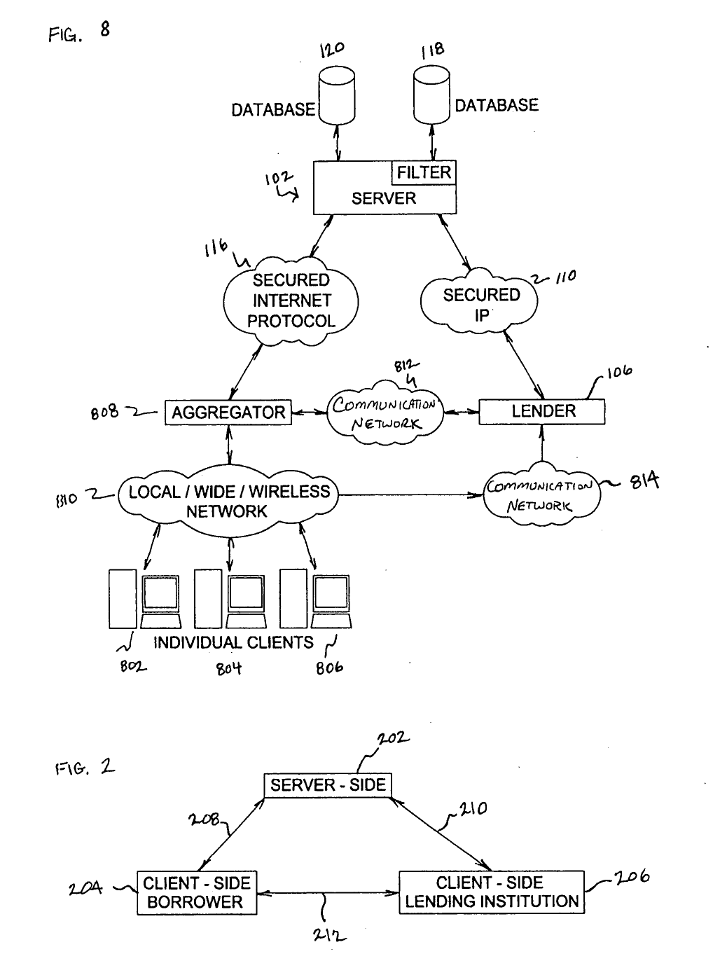

FIGS. 3-7 are drawings depicting schematics of the server-side architecture of the loan coordinating system according to one embodiment of the invention. For example, shown in FIG. 3 is a server subsystem 300 in which a server 302 is in data communications with a borrower client 304 and a lending institution client 306. The server may be in data communication with one or more databases 308, 310 for storing personal information received from borrowers 304 and selection criteria received from lending institutions 306. The server subsystem 300 includes a filtering process 312 for identifying lending institutions 306 that would be interested in loaning money to borrowers 304 based on personal information submitted to the server subsystem 300 by the borrower 304 and selection criteria submitted to the server subsystem 300 by the lending institution 306. The server 302 may also be in data communication with one or more third party information providers 314 for retrieving information relevant to generating a list of lending institutions which the borrower may contact or be contacted by. Third party information providers may include, but are not limited to, credit reporting bureaus, financial institutions, government agencies, or providers of data such as current interest rates, currency values, or other indicators of market conditions.

FIG. 4 is another drawing depicting a schematic of the server-side architecture of a server subsystem 400 according to another aspect of the present invention. In this case, one or more servers 402 are in data communications with one or more databases 404, 406. The server 402 may also be in data communication with one or more third party information providers 408, 410, 412 for retrieving information relevant to generating a list of lending institutions which the borrower may contact. Third party information providers may be, for example, credit reporting bureaus, financial institutions, government agencies, or providers of data such as current interest rates, currency values, or other indicators of market conditions. The server 402 and the third party information providers 408, 410, 412 are connected to a first data communications network 414. The particular connectivity of the server 402 and the third party information providers 408, 410, 412 to the first network 414 is for illustrative purposes only. The network 414 may be, for example, a wireless network used by mobile computing devices like cellular telephones, the Internet, an intranet, or some other network system.

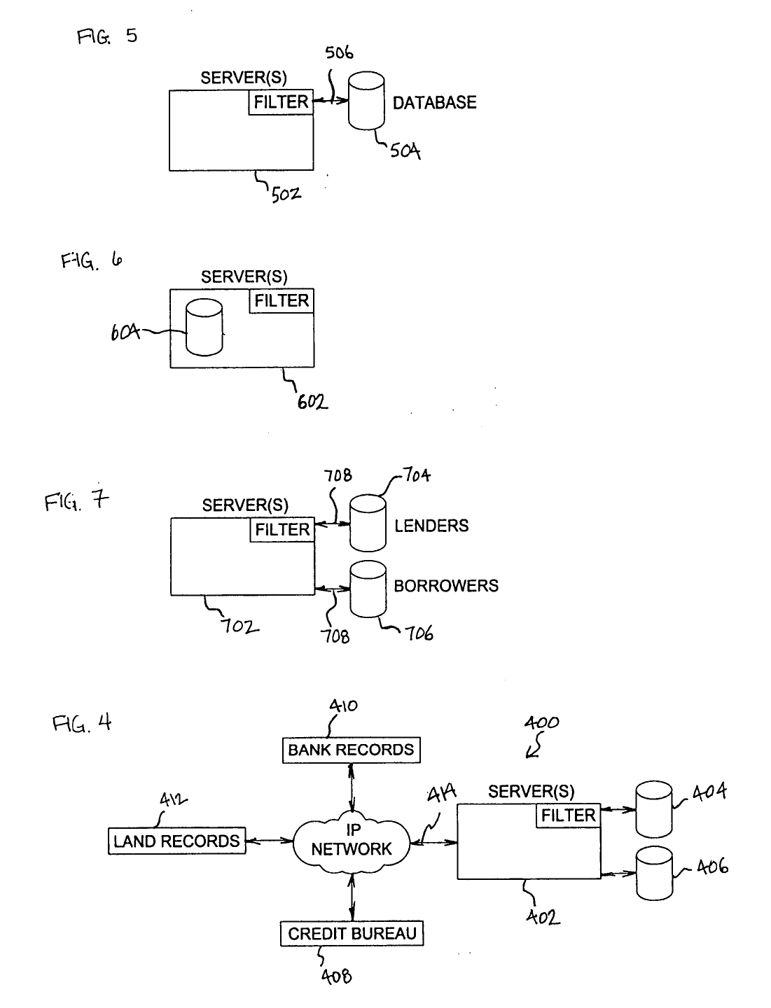

FIGS. 5-7 are additional drawings depicting schematics of the server-side architecture of a server subsystem, these representing different server-database architectures than those previously discussed. For example, FIG. 5 includes a server 502 in data communication with a database 504 external to the server 502 via a communications network 506. The database 504 can be used to store lending institution selection criteria and/or borrower personal information. The database 504 may be a single database repository that is centrally located proximate to the server 502, or it may consist of multiple databases distributed at various geographic locations. One of ordinary skill in the art will appreciate that there are many ways to construct and operate a database structure and manage database records that are not all located at a central database.

That concept is illustrated in FIG. 6, which is a drawing of a skematic showing a server 602 in data communication with a database 604 internal to the server 602. The database 604 can store lending institution selection criteria and/or borrower personal information.

In another embodiment, as shown in FIG. 7, a server 702 is in data communication with one or more databases 704, 706 external to the server 702 via a communications network 708. The databases 704, 706 can each store lending institution selection criteria and/or borrower personal information.

Further to the embodiment depicted in FIG. 1, FIG. 8 is a drawing depicting a schematic of the system architecture of a loan coordinating system 100 according to another aspect of the present invention. In the embodiment shown, individual borrower clients 802, 804, 806 (representing different users, who are not shown) are in data communication with an aggregator 808 via a communications network 810.

The aggregator 808 may be, for example, a student loan office of a university that handles processing of student loan requests by providing prospective and current students with an on-line personal account in which they can enter personal information and submit it to the university for transmission to the server subsystem 102. The aggregator 808 may instead be, for example, a third party provider that collects and manages information from multiple prospective borrowers for a fee, such as a lending institutions that aggregates information associated with all borrowers in a geographical location, or information associated with borrowers requesting a similar amount of borrowed money, or that satisfy some other specific criteria.

The aggregator 808 combines the personal information of the individual borrower clients 802, 804, 806 and sends the information to the server subsystem 102 via the communications network 116. The server subsystem 102 processes the personal information as described above, and returns to the aggregator 808, for example, contact information for matching lenders or HTML links to the web sites of identified lending institutions 106, as previously described. The aggregator 808 may then wait to be contacted by any or all of the matching lending institutions 106. Alternatively, the aggregator 808 may interface via a communications network 812 with the one or more identified lending institutions 106 directly using the HTML links in order to obtain favorable loan terms for the individual borrower clients 802, 804, 806, or it may pass on the HTML links to the individual borrower clients 802, 804, 806 which can then interface with the lender via a communications network 814.

When either the aggregator 808 or the individual borrower clients 802, 804, 806 click on an HTML link, a signal is sent via the communications network 116 to the server subsystem 102 to indicate a successful referral as previously described. The communications networks 116, 110, 810, 812, 814 can be separate communications network (as illustrated) or different networks (not shown).

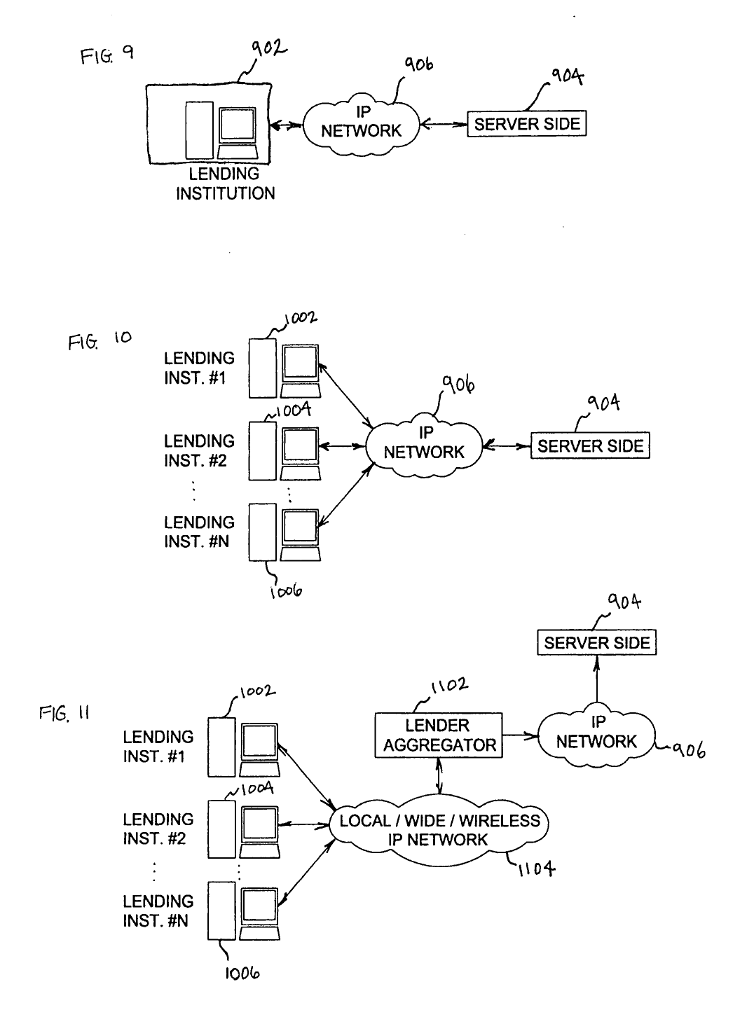

FIGS. 9-11 are drawings depicting schematics of the lending institution client-side architecture of a loan coordinating system according to still other embodiments of the present invention. For example, FIG. 9 depicts a lending institution subsystem 902 in data communication with the server subsystem 904 via the communications network 906.

FIG. 10 illustrates a plurality of lending institution subsystems 1002, 1004, 1006 in data communication with the server subsystem 904 via a communications network 906.

FIG. 11 illustrates the plurality of lending institution subsystems 1002, 1004, 1006 in data communication with a lending institution aggregator 1102 via a communications network 1104. The lending institution aggregator 1102 is in data communication with the server subsystem 904 via the communications network 906. The particular connectivity of the lending institution 902, 1002, 1004, 1006, the lending institution aggregator 1102 and the server subsystem 904 to the networks 906, 1104 is for illustrative purposes only. The lending institution aggregator 1102 may be, for example, a financial institution or a plurality of subsidiary financial institutions that, by aggregating selection criteria of the subsidiary financial institutions, allows the financial institution to more efficiently make loans across the subsidiary financial institutions. The networks 906, 1104 may be, for example, a wireless network used by mobile computing devices like cellular telephones, the Internet, an intranet, or some other network system.

FIGS. 12-15 are drawings depicting schematics of the borrower client-side architecture of a loan coordinating system according to still other embodiments of the present invention, these representing different borrower subsystem architectures. Borrowers, of course, may be consumers looking for student loans, automobile loans, home loans, or other financial debt instruments.

For example, FIG. 12 is a drawing of a schematic showing a basic borrower subsystem 1202 in data communication with the server subsystem 904 via a communications network 1204.

FIG. 13 is a drawing of a schematic illustrating a plurality of borrower subsystems 1302, 1304, 1306 in data communication with the server subsystem 904 via a communications network 1204.

FIG. 14 illustrates the plurality of borrower subsystems 1302, 1304, 1306 in data communication with a borrower aggregator 1402 via a communications network 1404. The borrower aggregator 1402 is in data communication with the server subsystem 904 via the communications network 906. The borrower aggregator 1402 may be, for example, a university financial aid department representing a plurality of students seeking student loans, as described above. By aggregating the personal information of a plurality of students, the university can more efficiently coordinate student loans for the plurality of students. The particular connectivity of the borrower subsystems 1302, 1304, 1306, the borrower aggregator 1402 and the server subsystem 904 to the networks 906, 1404 is for illustrative purposes only. The networks 906, 1404 may be, for example, a wireless network used by mobile computing devices like cellular telephones, the Internet, an intranet, or some other network system.

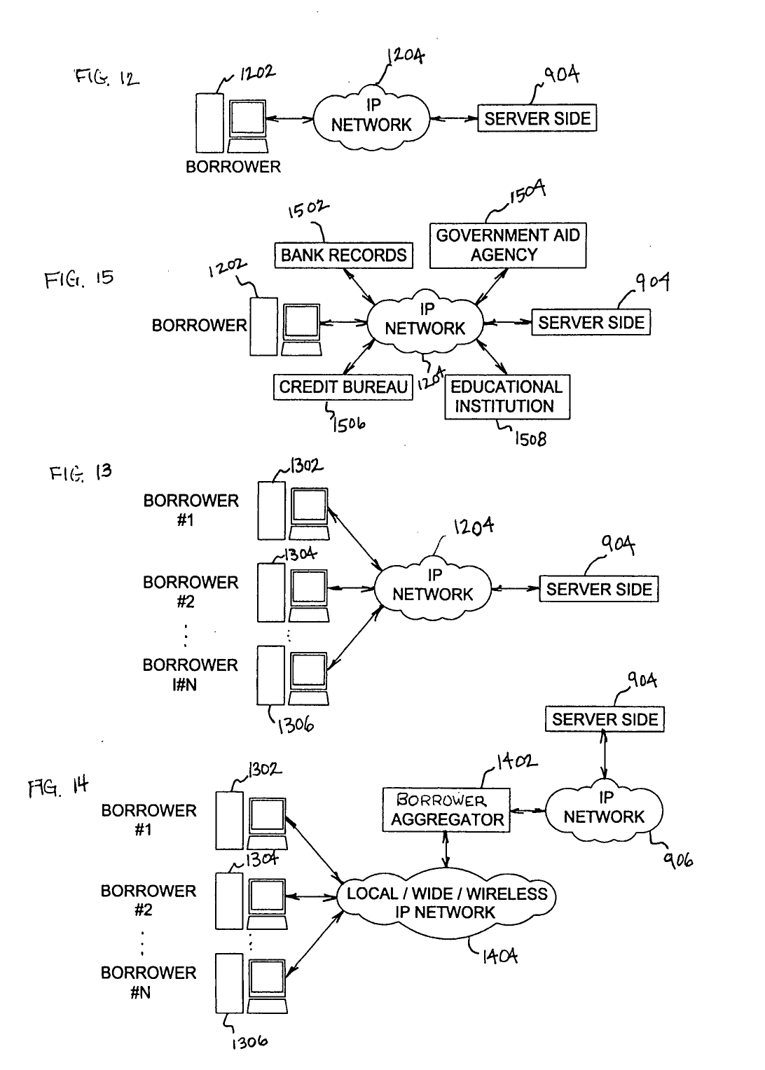

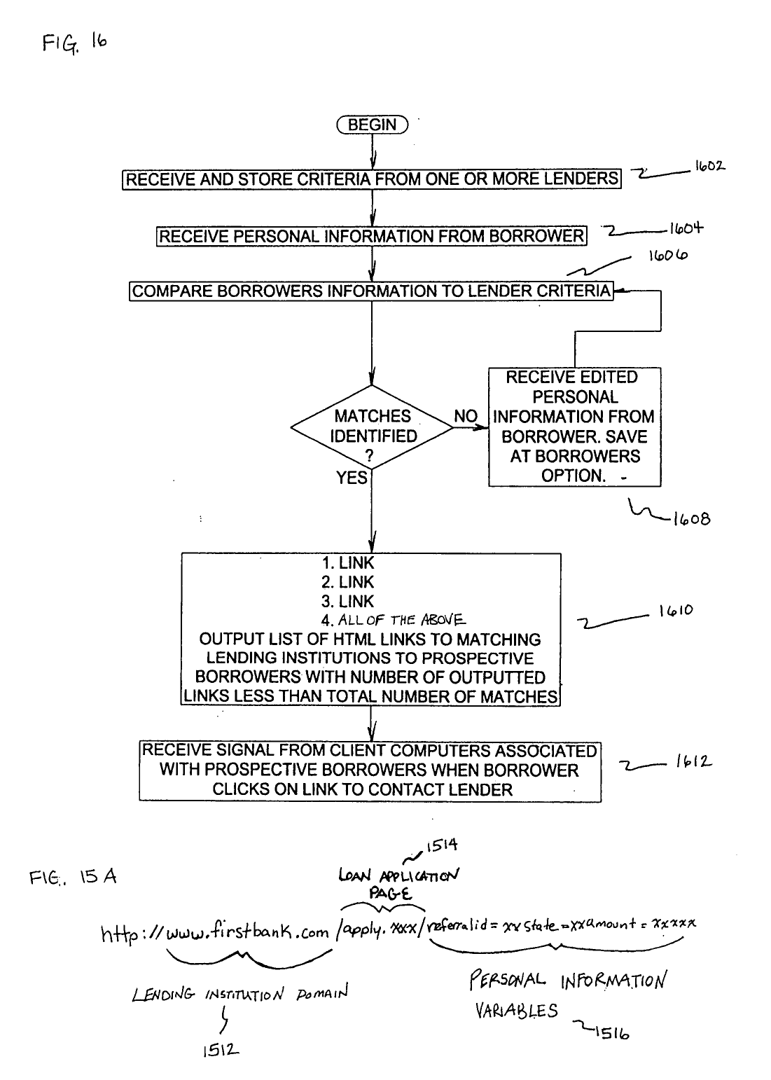

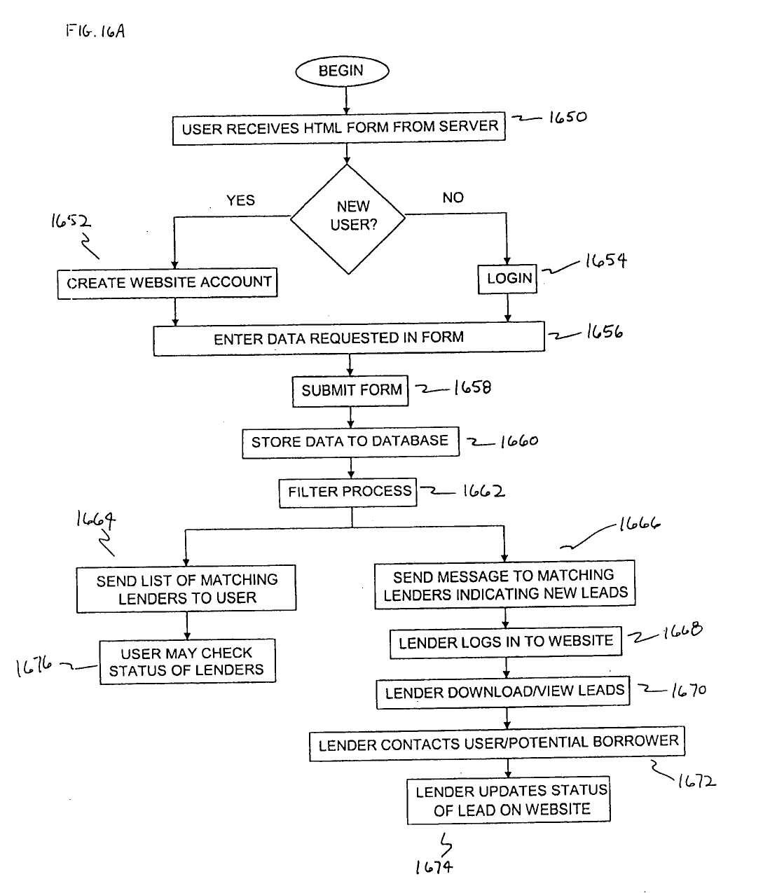

FIG. 15 is another drawing depicting a schematic of the borrower client-side architecture of a borrower subsystem according to another aspect of the present invention. In this case, a borrower subsystem 1202 is in data communications with one or more third party information providers 1502, 1504, 1506, 1508 for retrieving information relevant to submitting personal information requested by the server subsystem 904. Third party information providers may be, for example, credit reporting bureaus, financial institutions, government agencies, or educational institutions. The borrower subsystem 1202 and the third party information providers 1502, 1504, 1506, 1508 are connected to a first data communications network 1204. The particular connectivity of the borrower subsystem 1202 and the third party information providers 1502, 1504, 1506, 1508 to the first network 1204 is for illustrative purposes only. The network 1204 may be, for example, a wireless network used by mobile computing devices like cellular telephones, the Internet, an intranet, or some other network system.

FIG. 15A is a drawing representing an HTML link 1510 containing borrower personal information as described above. The link contains the domain name 1512 of an identified lending institution 106 to website to which the borrower 104 will be directed. The link also contains the filename 1514 of the particular webpage on the lending institution website to which the borrower should be directed. The borrower's personal information is stored as a series of variables 1516 that can be parsed by the lending institution web server. When the borrower clicks on a link, certain personal information is transmitted from the borrower client computer 114 to the lending institution 106 and can be used to, for example, pre-populate certain loan application forms.

II. System Operation.

FIG. 16 is a process flow diagram depicting the server-side process flow steps according to an embodiment of the present invention. In process step 1602, the server subsystem 102 receives at the web server 112 via a communication network 110 and stores in a database 118 selection criteria from one or more lending institutions 106.

In process step 1604, the server subsystem receives from a borrower 104 interested in borrowing money personal information about the borrower or another person. The personal information may be stored in a database 120. The personal information is checked for completeness and to ensure it satisfies certain quality standards (e.g., punctuation, missing characters, special formats for items like phone numbers and email addresses, etc.).

In process step 1606, the server subsystem 102 applies a filter 122 to determine whether the borrower's personal information matches any of the lending institutions' 106 selection criteria. If no matching lending institutions 106 are found, the server subsystem 102 informs the borrower 104 that there are no identified lending institutions 106 and the borrower 104 is given the opportunity to change the personal information entered and resubmit the information as depicted in process step 1608. The borrower 104 may choose to edit his or her personal information to reflect, for example, a smaller amount of money desired or the existence of a guarantor. The edited information is again checked for completeness and quality.

If one or more matching lending institutions 106 are found, as depicted in process step 1610, the server subsystem 102 will output to the borrower 104 a list of HTML links to the web sites of the one or more matching lending institutions 106, however the number of outputted links will be equal to or less than the total number of identified matching lending institutions, or at least one if there is only one match, the actual links being displayed to be determined at random or according to pre-determined criteria. In addition to allowing the borrower to contact any of the returned lending institution, the list of HTML links outputted to the user will provide the borrower with the option to contact all the returned lending institutions that are displayed.

In process step 1612, the server subsystem receives from the borrower's client computer 114 a signal indicating that the borrower 104 has clicked on one or more of the HTML links identifying matching lending institutions 106.

FIG. 16A is another process flow diagram depicting the client and server-side process flow steps according to an embodiment of the present invention. In process step 1650, a borrower/user 104 interfaces with the system 100 by visiting a website through a networked computer 114 via the server subsystem web server 112 or by some other means as described above. The networked computer 114 interfaces with the server subsystem web server 112 via a data communications network 116 and receives HTML pages.

As described in process step 1652, if the user is a new user, he is prompted to create a new website account. If the user is a returning user of the systems, he is prompted to log in as described in 1654.

In process step 1656, the borrower 104 supplies at least some of the personal information requested by the HTML forms displayed on the networked computer 114.

In process step 1658, the borrower 104 submits the personal information to the server subsystem web server 112.

In process step 1660, the borrower's 104 personal information is stored to a database 118.

In process step 1662, the server subsystem 102 applies a filter 122 to determine whether the borrower's 104 personal information matches any of the lending institutions' 106 selection criteria.

In process step 1664, the server subsystem 102 sends a list of matching lending institutions 106 to the borrower 104 optionally including the contact information of each lending institution 106. As shown in process step 1666, the server subsystem 102 also sends a notification to the identified lending institutions 106 that new leads have been generated by the system 100. The notification may contain one or more links that when activated cause the system 100 login screen to be displayed at the lending institution's computer

In process step 1668, the lender 106 logs in to the website as directed by the notification. The lender may view or download new leads identified by the system 100 as described in process step 1670. The lender 106 may then contact the borrower 104 that has been identified as meeting the lender's selection criteria directly by phone or other methods as described in process step 1672.

In process step 1674, the lender logs in to the website to update the status of the loan process with respect to the identified borrower. In process step 1676, the borrower may log in to the website to determine the status of the loan process with respect to each of the identified lenders.

FIG. 17 is a process flow diagram according to another embodiment of the present invention. In process step 1702, a borrower 104 interfaces with the system 100 by visiting a website through a networked computer 114 via the server subsystem web server 112 or by some other means as described above. The networked computer 114 interfaces with the server subsystem web server 112 via a data communications network 116 and receives HTML forms requesting personal information.

In process step 1704, the borrower 104 supplies at least some of the personal information requested by the HTML forms displayed on the networked computer 114. Supplying personal information may include creating a website account if the borrower is a new user of the system.

In process step 1706, the borrower 104 submits the personal information to the server subsystem web server 112.

In process step 1708, the borrower 104 receives a response from the server subsystem web server 112.

In process step 1710, if the borrower 104 does not receive from the server subsystem 102 an identified lending institution, the borrower 104 may modify the personal information in the HTML forms requesting personal information and resubmit the revised information to the server subsystem 102 as depicted in process step 1712, or the borrower may exit the system 100.

If the borrower 104 receives from the server subsystem 102 a list of one or more identified lending institutions 106, the borrower 104 may click on one or more of the HTML links to the one or more identified lending institutions 106 as depicted in process step 1714.

In process step 1716, the networked computer 114 sends a signal to the server subsystem 102 indicating that the borrower 104 has clicked one or more HTML links. This signal is recorded by the server subsystem 102 to manage the number of referrals being created using the system 100, and is also a check to see if the borrower 104 has acted on any of the information provided in the form of the HTML links.

The forms requesting personal information received from the web server 112 may include, but are not limited to, text entry fields, radio buttons, drop down boxes, and check boxes. For example, the borrower 104 may enter personal information about a self-assessment of his or her credit worthiness using a drop-down menu that asks whether the borrower 104 has “excellent,” “good,” or “poor,” credit, or which state the borrower 104 lives in.

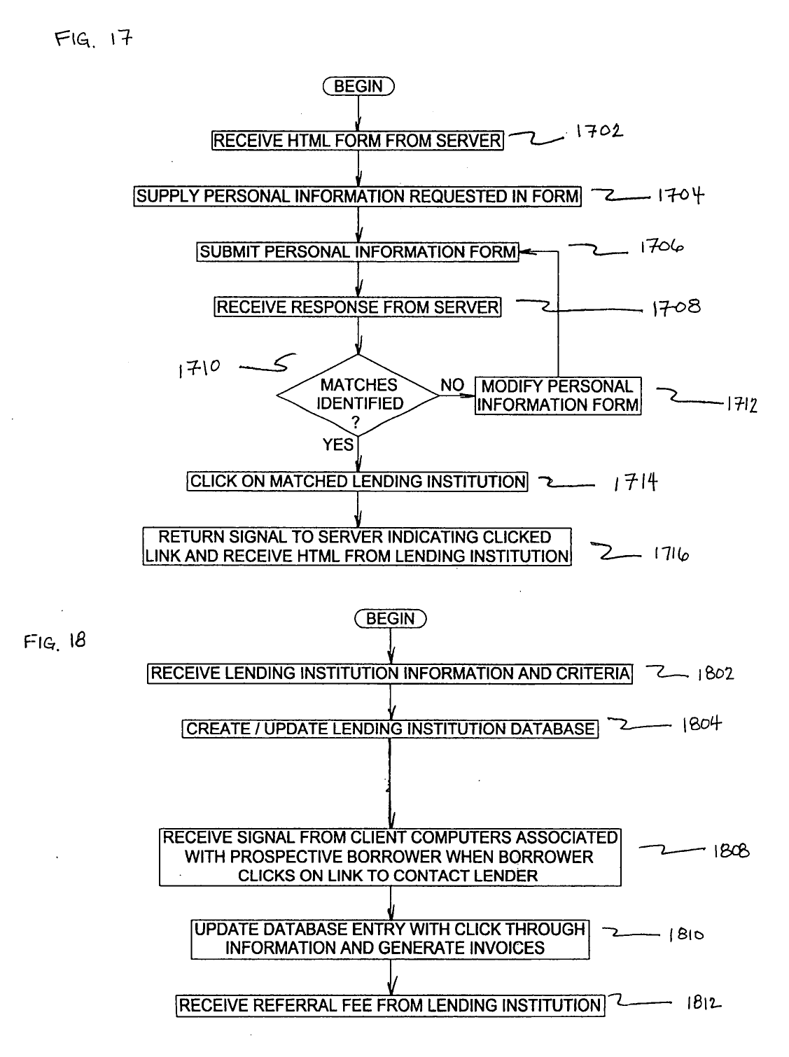

FIG. 18 provides a process flow diagram depicting the server-side referral tracking process flow according to a preferred embodiment of the present invention. In process step 1802, the web server 112 in the server subsystem 102 receives from a lending institution 106 information about the lending institution and the lending institution's selection criteria.

In process step 1804, the server subsystem 102 determines whether an entry for the lending institution 106 exists in the database 118. If an entry exists, the entry is updated with the information received from the lending institution 106. If no entry exists, a new entry is created in the database 118 using the received lending institution information and selection criteria. An entry in the database may include, but is not limited to, the name of the institution, the selection criteria, a record of successful referrals, and the referral fee paid by the lending institution to the referring agent.

In process step 1806, the server subsystem 102 transmits to a borrower 104 a file containing instructions to create a link, such as an HTML hyperlink, that points the borrower 102 to the lending institution web site 108 when the borrower's submitted personal information matches the selection criteria of a lending institution.

In process step 1808, the server subsystem 102 receives from the borrower networked computer 114 a signal indicating that the borrower clicked on the HTML link. The signal includes an indication of the lending institution web site HTML link on which the borrower clicked.

In process step 1810, the server subsystem 102 updates the entry in the database 118 for the particular lending institution to which the borrower was referred to reflect a successful referral.

In process step 1812, a referral fee is received from the lending institution 106 for any referrals of borrowers 104 made by the system 100. The server subsystem 102 may generate an invoice detailing the referrals made as recorded in the database 118 entry for a particular lending institution 106. The step of generating an invoice and sending the invoice to the lending institution may be automated and can be performed intermittently or at predetermined intervals.

Although certain presently preferred embodiments of the disclosed invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

I claim:

1. A method for referring money borrowers to lending institutions, comprising, at a first server, the steps of:
receiving over a first communications network a set of selection criteria from each of a plurality of lending institutions;
receiving over a second communications network a set of personal information from a first borrower;
comparing the set of personal information to each of the sets of selection criteria;
identifying which of the sets of selection criteria are satisfied by the set of personal information;
outputting to each of the identified lending institutions a first signal having information containing instructions to generate a link on a client computer; and
outputting to the borrower a second signal having information about the identified lending institutions; and
receiving a signal from the lending institutions when the link has been activated.

2. The method according to claim 1, further comprising the step of storing the selection criteria in a first storage medium.

3. The method according to claim 1, further comprising the step of storing the set of personal information in a first storage medium.

4. The method according to claim 1, further comprising the step of outputting an invoice in response to receiving the signal.

5. The method according to claim 1, wherein the link is activated by the first borrower.

6. The method according to claim 1, where the first and second communications networks are the same network.

7. The method according to claim 1, further comprising receiving at one of the plurality of lending institutions a signal having at least some of the first set of personal information.

8. The method according to claim 1, further comprising providing at the first server a second set of selection criteria.

9. The method according to claim 1, wherein the set of personal information includes information about the first borrower selected from the group consisting of name, address, age, name of school, address of school, amount of loan, assets, liabilities, credit score, employment history, residence history, social security number, and date of birth.

10. A method operable at a first server for generating referrals in a money lending environment via a computer network comprising:
sending to one or more lending institutions computer executable code for displaying and operating one or more selection criteria forms for entering one or more sets of selection criteria;
receiving from the one or more lending institutions the one or more sets of selection criteria entered into the one or more selection criteria forms;
storing on a first storage medium associated with the first server the one or more sets of selection criteria;
sending to one or more borrowers interested in borrowing money computer executable code for displaying and operating one or more personal information forms for entering a set of personal information;
receiving from the one or more borrowers the set of personal information entered into the one or more personal information forms;
comparing the set of personal information received from the one or more borrowers to the one or more sets of selection criteria stored on the first storage medium to identify at least one matching lending institution;
generating computer executable code for displaying and operating one or more referral forms listing one or more links to some of the personal information;
sending the computer executable code for displaying and operating the one or more referral forms to the one or more borrowers interested in borrowing money;
receiving a signal indicating that the lending institutions activated the one or more links; and
generating an invoice based on the signal indicating a referral.

11. The method according to claim 10, wherein the one or more referral forms comprise one or more HTML links to an Internet web site.

12. The method according to claim 11, wherein the one or more referral forms comprise an email.

13. A system for coordinating student loans comprising:
a server in data communication with one or more lending institution client computers, for entering and sending a plurality of selection criteria to the server, and one or more borrower client computers associated with borrowers interested in borrowing money, for entering and sending a set of personal information to the server;
a data processing subsystem for comparing the set of personal information to the plurality of selection criteria and returning a list of one or more matching lending institutions to the borrower and the lending institution client computers, wherein the list comprises at least one link; and
a signal receiving subsystem for receiving a signal from the lending institution client computers indicating an activation of the at least one link.

14. The system of claim 13, the server comprising a web server for serving Internet web pages.

15. The system of claim 13, wherein the at least one link is a hypertext link pointing to at least some of the personal information.

16. The system of claim 15, wherein each of the at least one link is associated with an account associated with the lending institution client computers.

17. The system of claim 16, further comprising means for computing the number of links activated.

18. The system of claim 13, further comprising a lending institution database accessible by the server containing a plurality of selection criteria for the one or more lending institutions.

19. The system of claim 13, further comprising a borrower database accessible by the server containing a plurality of sets of personal information for the one or more borrowers interested in borrowing money.

20. A system for coordinating student loans comprising, on a first server:
a storage medium in data communication with one or more client computers, the storage medium containing computer code operable to:
receiving over a communications network a first set of selection criteria from one or more lending institutions;
receiving over the communications network a first set of personal information from one or more borrowers interested in borrowing money;
comparing the first set of personal information to the first set of selection criteria to identify at least one lending institution interested in lending money to the one or more borrowers interested in borrowing money;
outputting over the communications network information containing instructions to generate a listing of the identified one or more lending institutions on one or more borrowers client computer and on the identified lending institution servers; and
receiving over the communications network a signal from one or more identified lending institution client computers indicating that the at least one identified lending institution has contacted the one or more borrowers.

21. The system of claim 20, further comprising a database for storing the first and second sets of information.
